(19) United States
(12) Patent Application Publication
(10) Pub. No.: US 2007/0218247 A1
(43) Pub. Date: Sep. 20, 2007

(54) Gas range knob shield

(76) Inventor: Vance Edward Holt, Cleveland Heights, OH (US)

Correspondence Address: Vance Edward Holt, 3732 Berkeley Road, Cleveland Heights, OH, 44118, US

(21) Appl. No.: 11/247,482

(22) Filed: Mar. 16, 2006

(51) Int. Cl. B32B 3/06

(52) U.S. Cl. 428/99

(57) ABSTRACT

Presently there are no Gas Range Shields being utilized on Gas Ranges that protects against unauthorized use. This Gas Range Shield will provide that protection and safety from accidental or unauthorized use of the Gas Controls on the range.

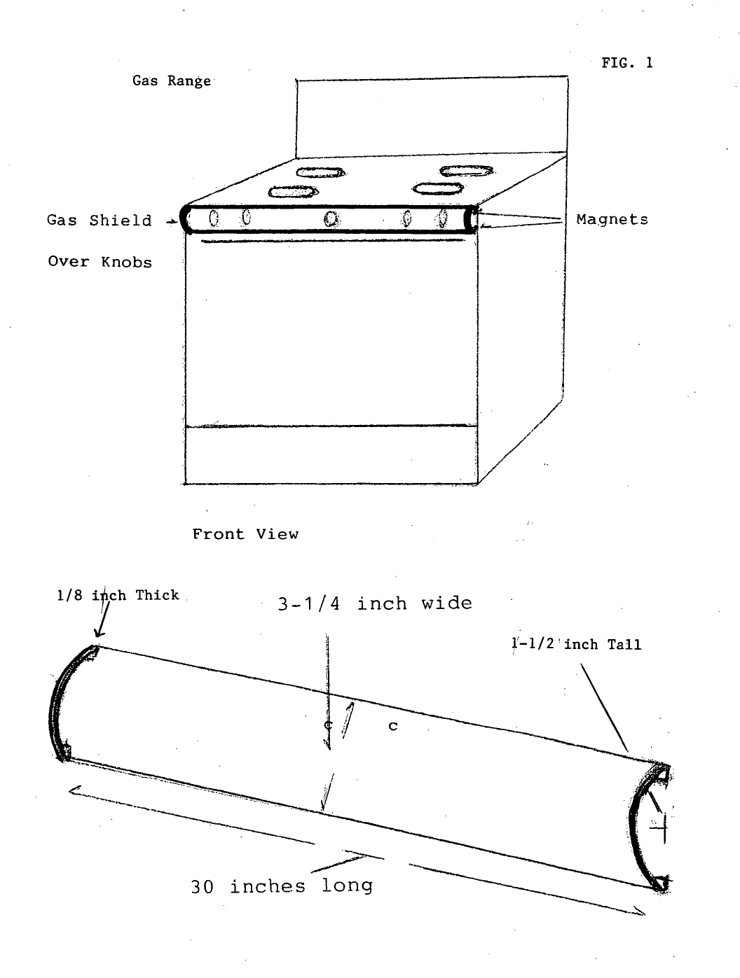

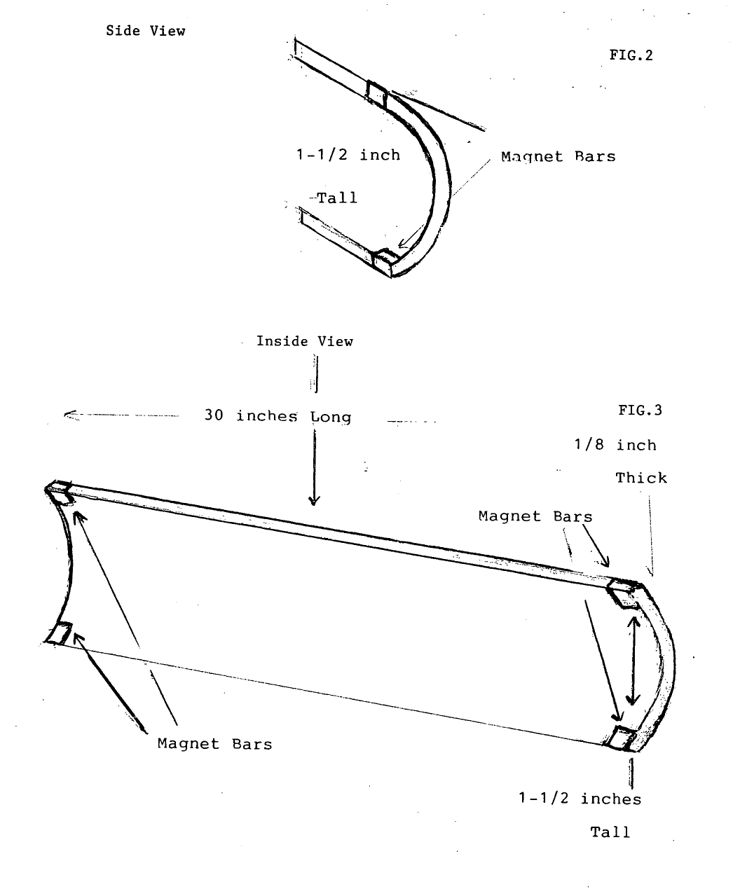

It is made from clear Polycarbonite. It is 3¼ inches wide by 30 inches in length. It is curbed at each end, measuring 1½ inches in height. There are magnetic bars on the four corners of the Shield to hold in place.

The Shield is placed directly onto the Gas Range covering the controls.

It is used as a safety Shield to prevent accidents or unauthorized use of the gas controls on the range.

The manufacturing of the Shield would occur at a company that would specialize in machining, laser cutting and custom fabricating.

The Polyearbonite would be measured, cut and outfitted with magnets by the company based upon orders for the Gas Shield.

1. I claim that the clear Polycarbonite shaped and formed as a Gas Knob Shield magnetized to adhere to the standard size Gas Range will prevent unauthorized usage of the Gas Controls for home safety purposes.
